(19) United States
(12) Patent Application Publication
(10) Pub. No.: US 2024/0086679 A1
(43) Pub. Date: Mar. 14, 2024

(54) METHODS AND APPARATUS TO TRAIN AN ARTIFICIAL INTELLIGENCE-BASED MODEL

(71) Applicant: The Nielsen Company (US), LLC, New York, NY (US)

(72) Inventor: Daniel John Krotov, Odessa, FL (US)

(21) Appl. No.: 17/943,022

(22) Filed: Sep. 12, 2022

(51) Int. Cl. G06N 3/04; G06N 3/08

(52) U.S. Cl. CPC G06N 3/04; G06N 3/08

(57) ABSTRACT

Methods, apparatus, systems, and articles of manufacture to train an artificial intelligence-based model are disclosed. An example apparatus includes memory; computer readable instructions; and processor circuitry to execute the computer readable instructions to: generate a location value for a neuron in an AI-based model; adjust a characteristic a sinusoidal signal based on a misclassification output by the AI-based model; determine that a trajectory of the sinusoidal signal is within a threshold distance of the location value; adjust the location value in response to the trajectory being within the threshold distance; and adjust a weight that corresponds to the neuron based on the adjusted location value.

### FIELD OF THE DISCLOSURE

This disclosure relates generally to machine learning, and, more particularly, to methods and apparatus to train an artificial intelligence-based model.

### BACKGROUND

In recent years, machine learning (ML) and/or artificial intelligence (AI) have increased in popularity. For example, machine learning and/or artificial intelligence may be implemented using neural networks. Neural networks are computing systems inspired by the neural networks of human brains. A neural network can receive an input and generate an output. The neural network can be trained (e.g., can learn) based on back propagation so that the output corresponds a desired result. Once trained, the neural network can make decisions to generate an output based on any input. Neural networks are used for the emerging fields of artificial intelligence and/or machine learning.

### BRIEF DESCRIPTION OF THE DRAWINGS

FIG. 1 is a schematic illustration of a training device including AI-based model training circuitry to generate an AI-based model in accordance with teachings of this disclosure.

FIG. 2 is a block diagram of an example neuron of the AI-based model training circuitry of FIG. 1.

FIG. 3 illustrates an example adjustment of locations of neurons corresponding to a weight adjustment during training of an AI-based model.

FIGS. 4 and 5 illustrate flowcharts representative of example machine readable instructions which may be executed to implement the example AI-based model training circuitry of FIGS. 1 and/or 2.

FIG. 6 is a block diagram of an example processing platform structured to execute the instructions of FIGS. 4 and/or 5 to implement the example AI-based model training circuitry of FIGS. 1 and/or 2.

FIG. 7 is a block diagram of an example implementation of the processor circuitry of FIG. 6.

FIG. 8 is a block diagram of another example implementation of the processor circuitry of FIG. 6.

FIG. 9 is a block diagram of an example software distribution platform (e.g., one or more servers) to distribute software (e.g., software corresponding to the example machine readable instructions of FIGS. 4 and/or 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

As used herein, connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

AI-based models, such as neural networks, machine learning models, etc., are used to perform a task (e.g., classify data). AI can include a training stage to train the model using ground truth data (e.g., data correctly labelled with a particular classification). Training a traditional AI-based model includes adjusting the weights of neurons of the AI-based model. After the model is trained, data is input into the trained AI-based model and the weights of the neurons are applied to input data to enable the model to process the input data to perform a function (e.g., classify data).

When training data corresponding to a known classification is entered into the AI-based model, if the output classification matches the known classification, the weights used during the classification are maintained. However, when training data corresponding to a known classification is entered into the AI-based model, if the output classification mismatches the known classification, the weights used during the classification should be adjusted to avoid the misclassification for subsequent input data. Conventional AI-based models use back propagation to adjust the weights when a misclassification of training data occurs during training. During back propagation, the weights used during a classification that was incorrect are adjusted and/or tuned one-by-one based on an error rate obtained in a previous epoch (e.g., iteration) to attempt to fix the misclassification. However, such training of an AI-based model involves a large amount of resources (e.g., hardware and/or time to complete).

Examples disclosed herein train an AI-based model using a continuous feedforward sinusoid (e.g., a sinusoid that is continuously fed into the input of the AI-based model). The sinusoid abstracts the neurons in an AI-model into positions (e.g., locations, coordinates, etc.) and adjusts the positions of the neurons when the trajectory and/or projection of the sinusoid comes within a threshold distance to the abstracted position information. Examples disclosed herein generate and/or adjust weights based on a distance between the neurons. The characteristics (e.g., vertical offset or shift, horizontal offset or shift, frequency, amplitude, period, number of sinusoids added to generate the sinusoid, an offset, a number of points on the sinusoidal signal, a height, a width, etc.) of the sinusoid are adjusted based on an error corresponding to an output classification when misclassification occurs. Adjusting the characteristics of the sinusoid adjusts the trajectory and/or projection of the sinusoid, which may change whether the sinusoid comes within a threshold distance of the same or different neurons, thereby changing the distance of the neurons. Changing the distance between neurons causes the weights corresponding to the neurons to be adjusted to fix the misclassification. Examples disclosed herein reduce the amount of resources and/or time needed to train an AI-based model as compared to approaches that use back propagation.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters may be used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training is performed until a threshold number of actions have been predicted. In examples disclosed herein, training is performed either locally (e.g. in the device) or remotely (e.g., in the cloud and/or at a server). Training may be performed using hyperparameters that control how the learning is performed (e.g., a learning rate, a number of layers to be used in the machine learning model, etc.). In some examples re-training may be performed. Such re-training may be performed in response to a new program being implemented or a new user using the device. Training is performed using training data. When supervised training may be used, the training data is labeled. In some examples, the training data is pre-processed.

Once training is complete, the model is deployed for use as an executable construct that processes an input and provides an output based on the network of nodes and connections defined in the model. The model is stored locally in memory (e.g., cache and moved into memory after trained) or may be stored in the cloud. The model may then be executed by the computer cores.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

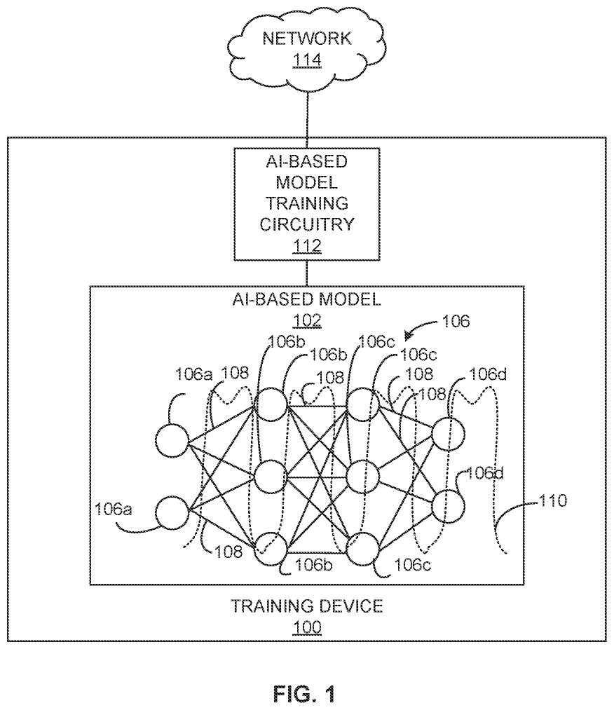

FIG. 1 is a schematic illustration of an example training device 100 to train an example AI-based model 102 in accordance with teachings of this disclosure. The example training device 100 includes an example AI-based model 102, example AI-based model training circuitry 112, and an example network 114. The example AI-based model 102 includes example neurons 106 (which include the example neurons 106a-106d, also referred to as nodes), example connections corresponding to weights, and an example sinusoidal signal 110. The example training device 100 may be a server, a computer, and/or any other type of computing and/or processing device.

The example AI-based model 102 of FIG. 1 is initially untrained. An untrained AI-based models includes the neurons 106 and the connections 108 of the neurons 106 (e.g., also referred to as nodes) between layers. The connections 108 correspond to weights that will be adjusted and/or set during the training protocol. The first column of neurons 106a represent the input nodes of a first layer. For example a first bit of bits of information of input data may be input into the first neuron of the neurons 106a. A second bit or bits of the input data may be input into the second neuron of the neurons 106b of a second layer after processing by the first neuron. The neurons 106a are connected to each of the neurons 106b of a second layer via the example connections 108. Each of the neurons 106b of the second layer are connected to each of the nodes 106c of a third layer via the example connections 108. Each of the nodes 106c of the third layer are connected to each of the nodes 106d of the output layer (e.g., the classification layer) via the example connections 108. Although the example AI-based model 102 includes two input nodes (106a), two middle layers with three nodes a piece (106b, 106c), and two output nodes (106d), the AI-based model 102 may include any number of input nodes, layers, nodes per layer, and/or output nodes. As further described below, each of the neurons 106 correspond to a grid location value that may be adjusted when the example sinusoidal signal 110 comes within a threshold distance to the grid location value of the neuron. The changes in location of the neurons 106 result in changes in the lengths of the connections 108. As further described below, the length of the connections 108 are used to determine the weights corresponding to the connections 108.

The example AI-based model training circuitry 112 of FIG. 1 trains the AI-based model 104 to perform a task (e.g., classification, data generation, etc.) using training data. Training data is input data labelled with known classifications and/or outputs. The AI-based model training circuitry 112 compares the known classifications and/or outputs for a particular input with the actual output of the AI-based model 104 when fed the particular input. The AI-based model training circuitry 112 can adjust the weights based on whether the output matches the output of the AI-based model. For example, the AI-based model training circuitry 112 may generate a grid-based (e.g., a location-based and/or coordinate plane-based) representation of the neurons 106 of the example AI-based model 104. Accordingly, each neuron 106 corresponds to a particular point in a grid. Additionally, the example AI-based model 104 generates the example sinusoidal signal 110 to be projected through the generated grid. The characteristics of the sinusoidal signal 110 is based on the error of the AI-based model 104. For example, if the output of the AI-based model 104 corresponds to a misclassification (e.g., corresponding to a large error), the characteristics of the sinusoid 110 are adjusted. If the AI-based model training circuitry 112 determines that the sinusoidal signal 110 projected onto the grid excites a neuron (e.g., comes within a threshold distance to the neuron), the AI-based model training circuitry 112 adjusts and/or moves the location value corresponding to the neuron based on the trajectory and/or projection of the sinusoidal signal 110 at and/or near the point of excitement (e.g., where the sinusoidal signal 110 comes into contact with and/or comes within the threshold distance to the neuron), as referred to as a collision point. The AI-based model training circuitry 112 determines and/or adjusts weight based on a distance between neurons in a subsequent layer (e.g., the closer the neurons are, the higher the weight associated with the neurons). After the AI-based model 104 is trained, the example AI-based model training circuitry 112 stores the AI-based model 104 and/or deploys the AI-based model to other devices via the example network 114.

The example AI-based model training circuitry 112 of FIG. 1 communicates to other devices (e.g., to deploy trained models and/or obtain training data) via the example network 114. The example network 114 communicatively couples computers and/or computing resources of the example training device 100. The example network 114 may be a wired network, a wireless network, a local area network, a wide area network, and/or any combination of networks.

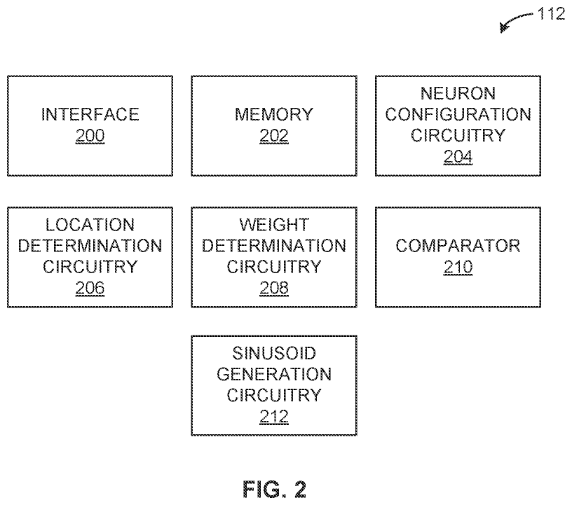

FIG. 2 is a block diagram of the example AI-based model training circuitry 112 of FIG. 1. The example AI-based model training circuitry 112 includes an example interface 200, example memory 202, example neuron configuration circuitry 204, example location determination circuitry 206, example weight determination circuitry 208, an example comparator 210, and example sinusoid generation circuitry 212.

The example interface 200 (also referred to as interface circuitry) of FIG. 2 obtains training data provided to train the example AI-based model 102 of FIG. 1. The training data may be input from other devices via the example network 114. Additionally, the example interface 200 may deploy and/or transmit trained model data corresponding to the example AI-based model 102 after training is complete. As described above, after training, the AI-based model 102 can perform tasks (e.g., classifications, data generation, etc.) based on input data after “learning” (e.g., generating weights that are applied to input data to generate an output) how to perform tasks from the training data. The example interface 200 may deploy the trained AI-based model 102 by transmitting information regarding how to implement the AI-based model at another device (e.g., the configuration of the AI-based model 102, the hyperparameters of the AI-based model 102, the generated weights of the AI-based model 102, etc.). In some examples, the interface 200 communicates with other components of the training device 100 (e.g., a user interface to obtain instructions from a user, wireless transmission circuitry to deploy trained AI-model data via the network 114, etc.).

The example memory 202 of FIG. 2 stores the training data and/or trained model data. The example memory 202 may be a database, a datastore, volatile memory, non-volatile memory, local memory, and/or any other type of memory. Other components of the example AI-based model training circuitry 112 can access and/or store data in the example memory 202.

The example neuron configuration circuitry 204 of FIG. 2 generates a configuration of neurons for the AI-based model 102. For example, the neuron configuration circuitry 204 can determine a number of neurons for each input layer, a number of middle layers, a number of neurons per middle layer, and a number of neurons for the output layer for implementing the example AI-based model 102. In some examples, the neuron configuration circuitry 204 determines the neuron configuration circuitry 204 based on instructions and/or preferences of a user. In some examples, the neuron configuration circuitry 204 determines the neuron configuration circuitry 204 based on the task that the AI-based model 102 is being trained to perform.

The example location determination circuitry 206 of FIG. 2 generates location values corresponding to a location of the neurons in the AI-based model 102. For example, initially, when the AI-based model 102 is untrained, the location determination circuitry 206 initiates the values for the neurons where each neuron of a particular layer has the same x-axis value and different y-axis values, where each layer corresponds to a different x-axis value. For example, using the example AI-based model 102 of FIG. 1, the location determination circuitry 206 may generate a first location for the first neuron of the input neurons 106a to be (0, 0), a second location for the second neuron of the input neurons 106a to be (0, 10), a third location for the first neuron of the neurons 106b to be (10, −5), a fourth location for the second neuron of the neurons 106b to be (10, 5), a fifth location for the third neuron of the neurons 106b to be (10, 15), etc. Thus, in this example, each layer is separated by 10 units.

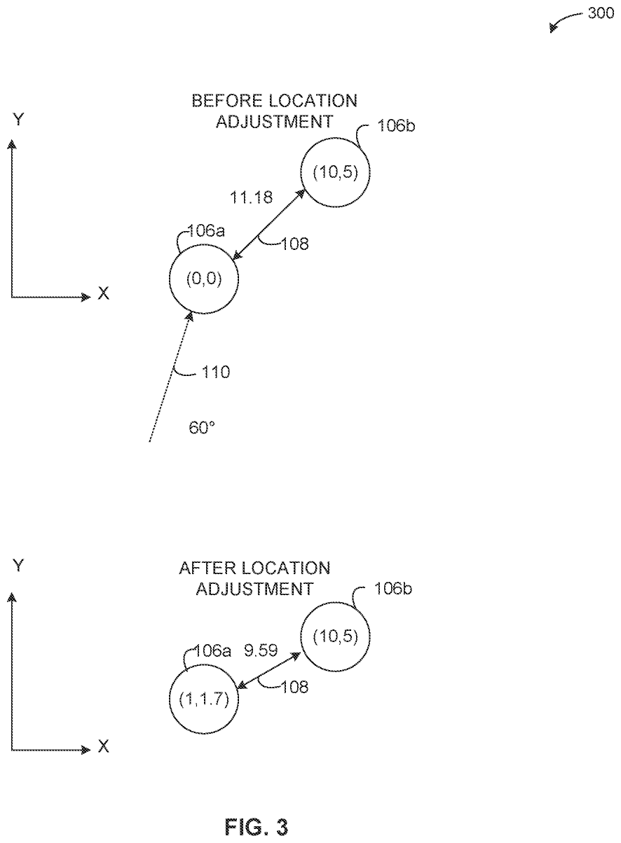

After the example sinusoid 110 is applied to the generated grid (e.g., projected onto the generated grid), the example location determination circuitry 206 of FIG. 2 adjusts any neurons 106 that of which the sinusoid 110 comes within a threshold distance. For example, if the sinusoid 110 comes within a threshold distance of a first neuron, the location determination circuitry 206 adjusts the value for the location (e.g., the x and/or y coordinate of the neuron 106) by a space (e.g., 1 unit) in a direction corresponding to the trajectory of the sinusoid 110 (e.g., the angle and/or slope of the sinusoid at or near the point where the sinusoid 101 is within the threshold distance to the neuron 106). The location determination circuitry 206 can determine the trajectory of the sinusoid 110 based on algebraic, geometric, trigonometric, and/or calculus principles. An example of the location determination circuitry 206 adjusting the location values of a neuron is further described below in conjunction with FIG. 3.

The example weight determination circuitry 208 of FIG. 2 adjusts the weights of the AI-based model 102 based on the distances between neurons of subsequent layers (e.g., the determined lengths of the example connections 108). For example, the weight determination circuitry 208 determines the length between each of the neurons 106a of the input layer and each of the neurons 106b of the first middle layer (e.g., corresponding to the connections 108 between the input layer and the first middle layer). The weight determination circuitry 208 can determine the length by using a distance formula (e.g., d=\sqrt{(x₁−x₂)²+(y₁−y₂)²}) based on the location values of the neurons. After the lengths of each connection 108 is determined, the example weight determination circuitry 208 determines a weight for each of the connections 108 based on the distance. For example, the shorter the connection, the larger the weight assigned to the connection 108 and the longer the connection the smaller the weight assigned to the connection 108. In some examples, the weight determination circuitry 208 recalculates the weights each time locations of the neurons 106 are adjusted.

The example comparator 210 of FIG. 2 compares the output of the AI-based model 102 to the known output of the training data to determine an amount of error associated with the output. As described above, if the comparator 210 determines that the output of the AI-based model 102 does not match the output of the training data (e.g., the output corresponds to a misclassification), the sinusoidal generation circuitry 212 adjusts the characteristics of the sinusoid 110 based on the error.

The example sinusoid generation circuitry 212 of FIG. 2 generates the sinusoidal signal 110 and/or adjusts the characteristics of the sinusoidal signal 110 based on the output of the comparator 210. For example, the sinusoid generation circuitry 212 may initiate the sinusoid to have initial characteristics (e.g., frequency, number of sinusoids added to generate the sinusoid signal 110, amplitude, period, shifts, etc.). After the comparator 210 determines whether the output of the AI-based model 102 matches the labeled output and/or how close the classification was (e.g., the amount of error), the sinusoidal generation circuitry 212 adjusts the one or more of the characteristics to attempt to reduce the error. In some examples, the sinusoidal generation circuitry 212 is an AI-based model that has been trained to generate characteristic adjustments based on error.

FIG. 3 illustrates an example 300 of how weights are adjusted based on the example sinusoidal signal 110 of FIG. 1. The example 300 of FIG. 3 includes neurons 106a, 106b, and the example connection 108 of FIG. 1. In the example of FIG. 3, before the location adjustment, the value of the location for the first neuron 106a is (0, 0) and the value of the location for the second neuron 106b is (10, 5). Accordingly, the example weight determination circuitry 208 determines that the length of the connection 108 (e.g., the distance between the neurons 106a, 106b) is 11.18 (e.g., \sqrt{(10−0)²+(5−0)²})). Thus, the weight determination circuitry 208 generates a weight for the connection corresponding to the length of 11.18. In the example 300, the sinusoid 110 excites the example neuron 106a (e.g., comes within a threshold distance from the neuron 106a). Thus, the example location determination circuitry 206 determines the trajectory (e.g., angle) of the sinusoid 110 at and/or near the point of excitement. The example location determination circuitry 206 may determine the trajectory (e.g., 60°) by taking a derivative of the sinusoid 110 at and/or near the point of excitement and/or may determine the slope of the sinusoid by taking two points at and/or near the point of excitement and using the slope to identify the trajectory/angle. After the trajectory/angle is determined, the example location determination circuitry 206 adjusts the location of the neuron 106a by X units (e.g., one unit for the example 300 of FIG. 3) based on the trajectory. For example, moving the neuron 106a X units (e.g., one unit) at a 60° angle results in an adjustment of the location value of the neuron 106a from (0, 0) to (1, 1.7). Although the X units in the example 300 is one unit, the number of units can be any number of units. After the location value is adjusted, the weight determination circuitry 208 determines the updated distance of the connection 108 between the neuron 106a and neuron 106b to be 9.59, which is smaller than 11.18 (e.g., the before adjustment distance). Accordingly, the example weight determination circuitry 208 will increase the weight associated with the connection 108.

While an example manner of implementing the AI-based model training circuitry 112 of FIG. 1 is illustrated in FIG. 2, one or more of the elements, processes and/or devices illustrated in FIGS. 1- and/or 2 may be combined, divided, re-arranged, omitted, eliminated and/or implemented in any other way. Further, the example interface 200, the example memory 202, the example neuron configuration circuitry 204, the example location determination circuitry 206, the example weight determination circuitry 208, the example comparator 210, the example sinusoid generation circuitry 212, and/or, more generally, the example AI-based model training circuitry 112 of FIG. 2, may be implemented by hardware alone or by hardware in combination with software and/or firmware. Thus, for example, any of the example interface 200, the example memory 202, the example neuron configuration circuitry 204, the example location determination circuitry 206, the example weight determination circuitry 208, the example comparator 210, the example sinusoid generation circuitry 212, and/or, more generally, the example AI-based model training circuitry 112 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example AI-based model training circuitry 112 may include one or more elements, processes, and/or devices in addition to, or instead of, those illustrated in FIG. 2, and/or may include more than one of any or all of the illustrated elements, processes and devices.

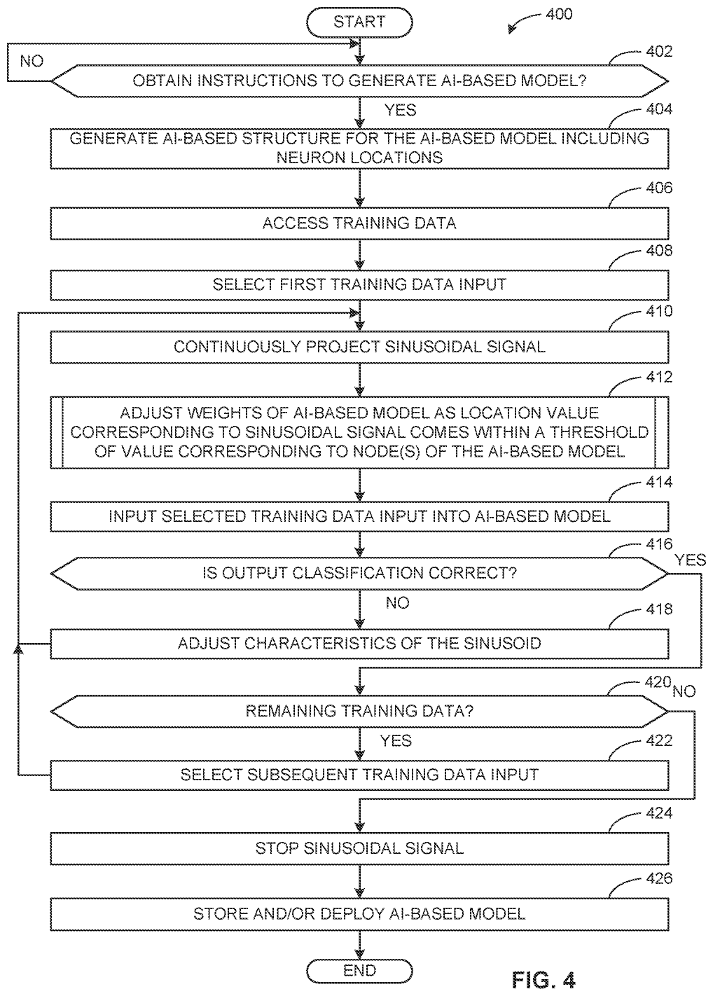

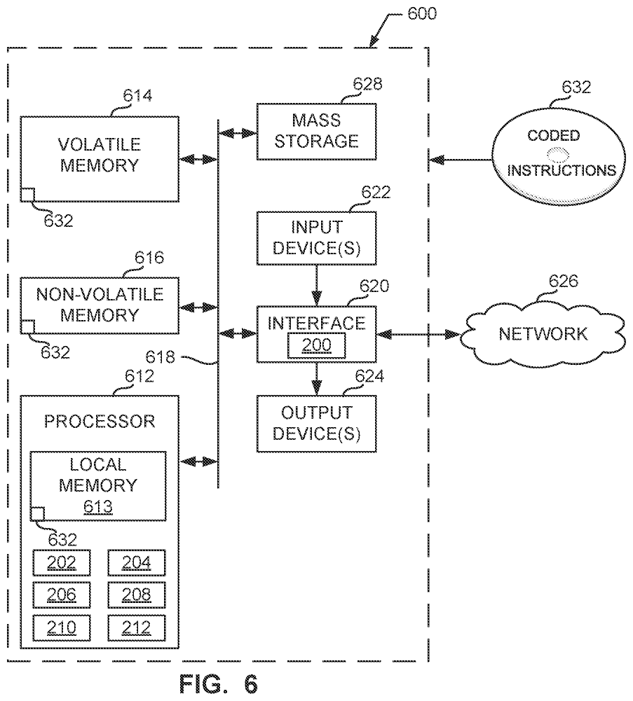

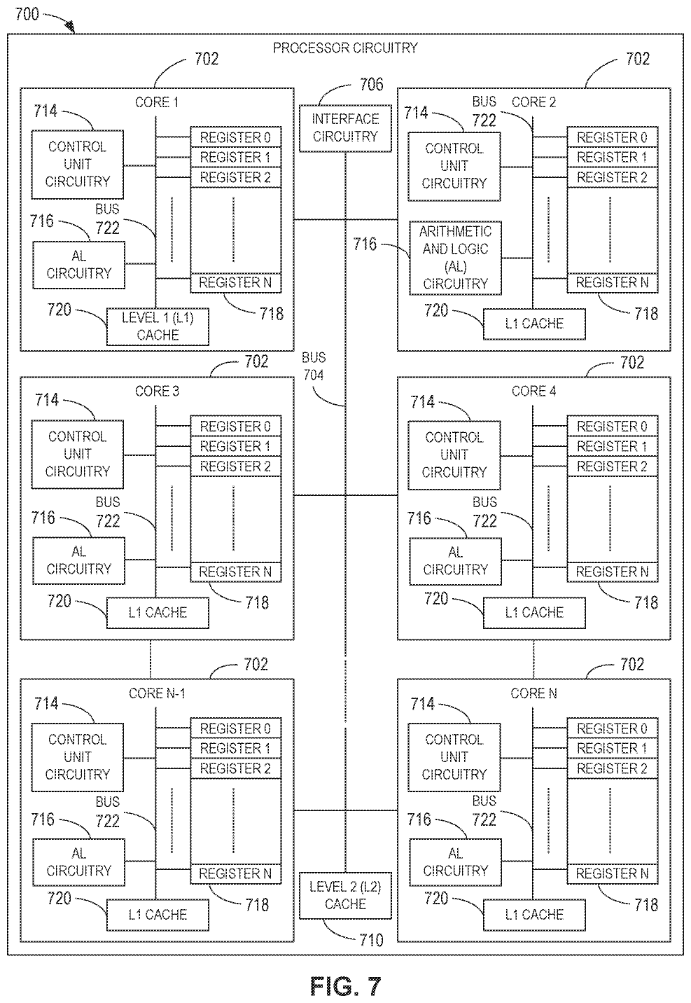

Flowcharts representative of example machine readable instructions, which may be executed to configure processor circuitry to implement the AI-based model training circuitry 112 of FIG. 2, are shown in FIGS. 4 and/or 5. The machine readable instructions may be one or more executable programs or portion(s) of an executable program for execution by processor circuitry, such as the processor circuitry 612 shown in the example processor platform 600 discussed below in connection with FIG. 6 and/or the example processor circuitry discussed below in connection with FIGS. 7 and/or 8. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4 and/or 5, many other methods of implementing the example AI-based model training circuitry 112 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 4 and/or 5 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry (e.g., the example AI-based model training circuitry 112) to train an AI-based model. The machine readable instructions and/or the operations 400 of FIG. 4 begin at block 402, at which the example neuron configuration circuitry 204 determines if instructions to generate the AI-based model 102 to perform one or more tasks has been obtained via the interface 200. The instructions may be obtained from another component (e.g., a user interface) or device.

If the example neuron configuration circuitry 204 determines that instructions have not been obtained (block 402: NO), control returns to block 402 until the instructions have been obtained. If the example neuron configuration circuitry 204 determines that instructions have been obtained (block 402: YES), the example neuron configuration circuitry 204 generates an AI-based structure for the AI-based model 102 and the example location determination circuitry 206 generates values for the location of the neurons in the AI-based model 102 (block 404). The structure corresponds to the number of layers, number of neurons, hyperparameters, etc. for the AI-based model 102. The structure may be based on instructions from a user, accuracy of the AI-based model 102, and/or complication of one or more tasks to be performed by the AI-based model 102. Additionally, the example location determination circuitry 206 can generate the initial positions/location data of the neurons in the AI-based model 102. The location data corresponds to a grid-based location data of each neuron (e.g., x and y coordinates for each neuron).

At block 406, the example interface 200 accesses training data from the example memory 202. As described above, training data is input data that has been labelled with a correct and/or verified output. At block 408, the example interface 200 selects a first training data input from the accessed training data. At block 410, the example sinusoid generation circuitry 212 continuously (e.g., more than once, repeatedly, periodically, aperiodically, etc.) projects, and/or outputs the example sinusoidal signal 110 onto a grid corresponding to the location values of the neurons 106. The sinusoidal signal 110 corresponds to initial characteristics that may be changed during the training process so that the AI-based model is trained to perform the intended task(s). In some examples, the sinusoidal signal 110 is not initiated and/or generated until after a first classification and/or first misclassification of the AI-based model 102. In this manner, the characteristics of the initial sinusoidal signal 110 can be based on the first classification and/or misclassification.

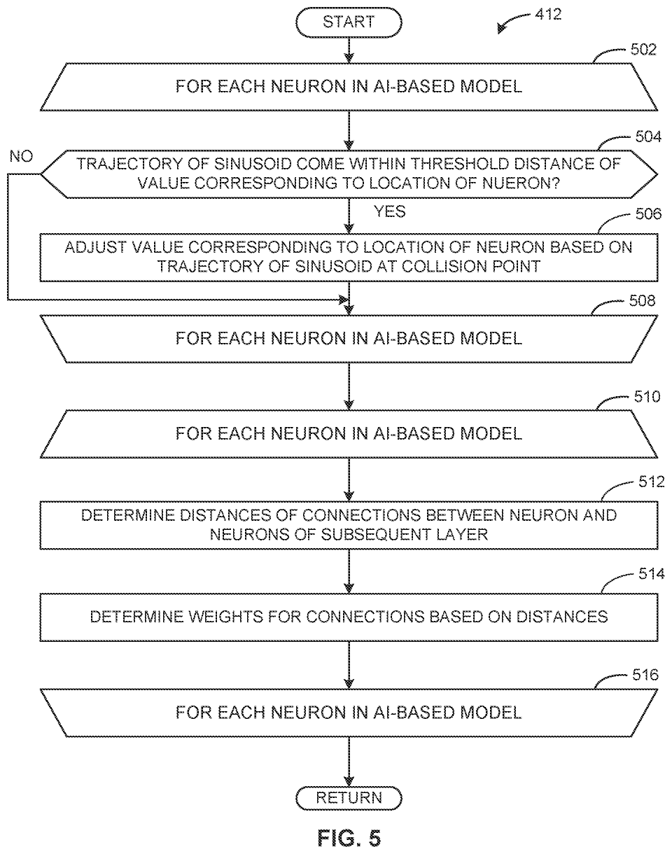

At block 412, the example AI-based model training circuitry 112 adjusts (e.g., tunes) the weights of the AI-based model 102 as the location values(s) corresponding to the sinusoidal signal 110 come(s) within a threshold of the location value corresponding to the neurons(s) 106 of the AI-based model 102, as further disclosed below in conjunction with FIG. 5. At block 414, the example interface 200 inputs the selected training data into the AI-based model 102. The AI-based model 102 processes the input data to generate an output (e.g., an output classification). At block 416, the example comparator 210 determines if the output classification is correct. For example, the comparator 210 compares the output to the labelled output to determine if they match or if they mismatch (e.g., corresponding to a misclassification). If the example comparator 210 determines that the output classification is correct (block 416: YES), control will continue to block 420. If the example comparator 210 determines that the output classification is not correct (block 416: NO), the example sinusoid generation circuitry 212 adjusts the characteristics of the sinusoidal signal 110 based on the error between the output from the AI-based model 102 and the known output of the training data (block 418).

At block 420, the example interface 200 determines if there is any more remaining training data in the example memory 202 for additional training. In some examples, the interface 200 only selects a percentage of the training data so there is additional training data to test the AI-based model 102 for accuracy. If the example interface 200 determines that there is remaining training data (block 420: YES), the interface 200 selects a subsequent training data input (block 422) and control returns to block 410 to perform another iteration of training. If the example interface 200 determines that there is no more remaining training data (block 420: NO), the example sinusoid generation circuitry 212 stop generating the sinusoidal signal 110 (block 424). At block 426, the example interface 200 stores (e.g., in the example memory 202) and/or deploys (e.g., to another device via the network 114) the trained AI-based model 102.

FIG. 5 is a flowchart representative of example machine readable instructions and/or example operations 412 that may be executed and/or instantiated by processor circuitry (e.g., the example AI-based model training circuitry 112) to adjust the weights of the AI-based model 102 as the location values(s) corresponding to the sinusoidal signal 110 come(s) within a threshold of the location value corresponding to the neurons(s) 106 of the AI-based model 102, as disclosed above in conjunction with block 412 of FIG. 4. The machine readable instructions and/or the operations 412 of FIG. 5 are executed for each neuron in the AI-based model 102 (blocks 502-508), at which the example location determination circuitry 206 determines if the trajectory and/or projection of the sinusoidal signal 110 has entered within a threshold distance of the value corresponding to the location of the neuron (block 504).

If the example location determination circuitry 206 determines that the trajectory of the sinusoid signal 110 does not come within a threshold distance of the value corresponding to the location of the neuron (block 504: NO), control returns to block 508 to process the remaining neurons. If the example location determination circuitry 206 determines that the trajectory of the sinusoid signal 110 comes within a threshold distance of the value corresponding to the location of the neuron (block 504: YES), the example location determination circuitry 206 adjusts the value corresponding to the location of the neuron based on the trajectory of the sinusoid at the collision point (block 506). As disclosed above in conjunction with FIGS. 2 and/or 3, the example location determination circuitry 206 determines the trajectory of the sinusoidal signal 110 based on a derivative and/or based on the slope of two points on or near the point of excitement (e.g., excitement point and/or collision point) and moves the neuron X units along the determined trajectory.

After each neuron has been processed for location adjustment, the example AI-based model training circuitry 112 processes each neuron in the AI-based model 102 to determine the weights (blocks 510-516). At block 512, the example weight determination circuitry 208 determines the distances of the connections 108 between the neuron and neurons of a subsequent layer, as disclosed above in conjunction with FIG. 3. At block 514, the example weight determination circuitry 208 determines a weight for each of the connections 108 based on the determined distances of the connections 108. As disclosed above, the higher the distance, the lower the weight assigned to the connection 108 and the lower the distance, the higher the weight assigned to the connection 108. At block 516, control returns to block 414 of FIG. 4.

FIG. 6 is a block diagram of an example processor platform 600 structured to execute the instructions of FIGS. 4 and/or 5 to implement the example AI-based model training circuitry 112 of FIGS. 1 and/or 2. The processor platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 600 of the illustrated example includes a processor 612. The processor 612 of the illustrated example is hardware. For example, the processor 612 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 612 implements at least one of the example neuron configuration circuitry 204, the example location determination circuitry 206, the example weight determination circuitry 208, the example comparator 210, and/or the example sinusoid generation circuitry 212 of FIG. 2.

The processor 612 of the illustrated example includes a local memory 613 (e.g., a cache). The processor 612 of the illustrated example is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 616 may be implemented by flash memory and/or any other desired type of memory device. Access to the main memory 614, 616 is controlled by a memory controller. The example local memory 613, the example volatile memory 614, and/or the example non-volatile memory 616 can implement the memory 202 of FIG. 2.

The processor platform 600 of the illustrated example also includes an interface circuit 620. The interface circuit 620 may be implemented by any type of interface standard, such as an Ethernet interface, a universal serial bus (USB), a Bluetooth® interface, a near field communication (NFC) interface, and/or a PCI express interface. The example interface circuit 620 implements the example interface 200 of FIG. 2

In the illustrated example, one or more input devices 622 are connected to the interface circuit 620. The input device(s) 622 permit(s) a user to enter data and/or commands into the processor 612. The input device(s) can be implemented by, for example, an audio sensor, a microphone, a camera (still or video), a keyboard, a button, a mouse, a touchscreen, a track-pad, a trackball, and/or a voice recognition system.

One or more output devices 624 are also connected to the interface circuit 620 of the illustrated example. The output devices 624 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 620 of the illustrated example, thus, typically includes a graphics driver card, a graphics driver chip and/or a graphics driver processor.

The interface circuit 620 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 626. The communication can be via, for example, an Ethernet connection, a digital subscriber line (DSL) connection, a telephone line connection, a coaxial cable system, a satellite system, a line-of-site wireless system, a cellular system, etc.

The processor platform 600 of the illustrated example also includes one or more mass storage devices 628 for storing software and/or data. Examples of such mass storage devices 628 include floppy disk drives, hard drive disks, compact disk drives, Blu-ray disk drives, redundant array of independent disks (RAID) systems, and digital versatile disk (DVD) drives.

The machine executable instructions 632 of FIGS. 4 and/or 5 may be stored in the mass storage device 628, in the volatile memory 614, in the non-volatile memory 616, and/or on a removable non-transitory computer readable storage medium such as a CD or DVD.

FIG. 7 is a block diagram of an example implementation of the processor circuitry 612 of FIG. 6. In this example, the processor circuitry 612 of FIG. 6 is implemented by a microprocessor 700. For example, the microprocessor 700 may be a general purpose microprocessor (e.g., general purpose microprocessor circuitry). The microprocessor 700 executes some or all of the machine readable instructions of the flowchart of FIGS. 4 and/or 5 to effectively instantiate the circuitry of FIG. 2 as logic circuits to perform the operations corresponding to those machine readable instructions. In some such examples, the circuitry of FIG. 2 is instantiated by the hardware circuits of the microprocessor 700 in combination with the instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIGS. 4 and/or 5

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating point operations. In yet other examples, the AL circuitry 716 may include first AL circuitry that performs integer based operations and second AL circuitry that performs floating point operations. In some examples, the AL circuitry 716 may be referred to as an Arithmetic Logic Unit (ALU). The registers 718 are semiconductor-based structures to store data and/or instructions such as results of one or more of the operations performed by the AL circuitry 716 of the corresponding core 702. For example, the registers 718 may include vector register(s), SIMD register(s), general purpose register(s), flag register(s), segment register(s), machine specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure including distributed throughout the core 702 to shorten access time. The second bus 722 may be implemented by at least one of an I2C bus, a SPI bus, a PCI bus, or a PCIe bus

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

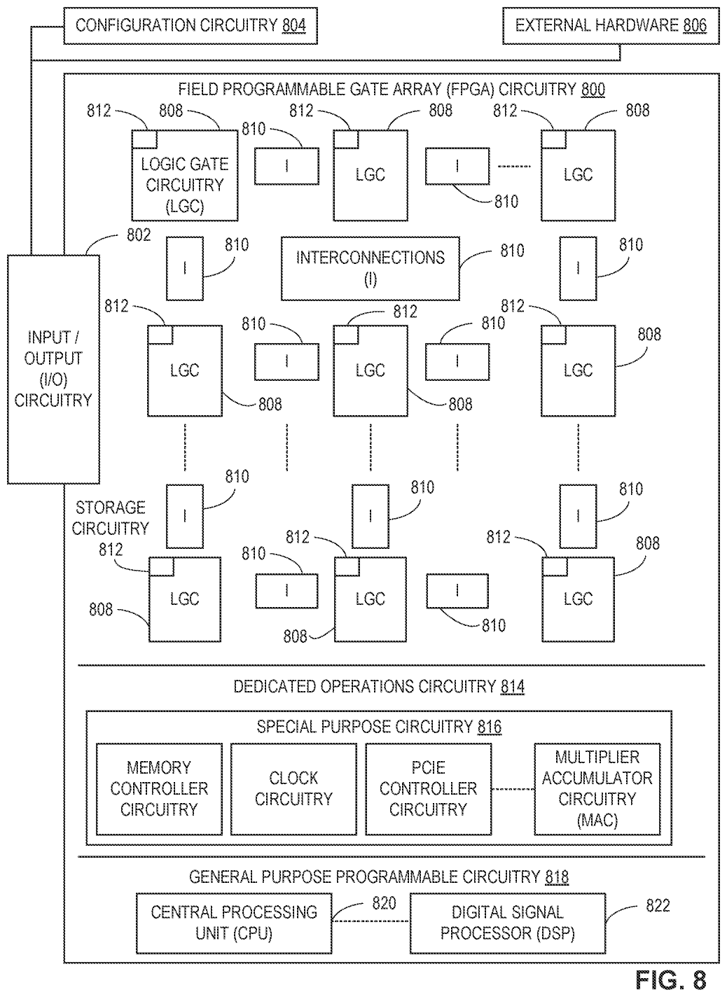

FIG. 8 is a block diagram of another example implementation of the processor circuitry 612 of FIG. 6. In this example, the processor circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the machine readable instructions in hardware and, thus, can often execute the operations faster than they could be performed by a general purpose microprocessor executing the corresponding software.

More specifically, in contrast to the microprocessor 700 of FIG. 7 described above (which is a general purpose device that may be programmed to execute some or all of the machine readable instructions represented by the flowchart of FIGS. 4 and/or 5 but whose interconnections and logic circuitry are fixed once fabricated), the FPGA circuitry 800 of the example of FIG. 8 includes interconnections and logic circuitry that may be configured and/or interconnected in different ways after fabrication to instantiate, for example, some or all of the machine readable instructions represented by the flowchart of FIGS. 4 and/or 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the software represented by the flowchart of FIGS. 4 and/or 5 As such, the FPGA circuitry 800 may be structured to effectively instantiate some or all of the machine readable instructions of the flowchart of FIG. as dedicated logic circuits to perform the operations corresponding to those software instructions in a dedicated manner analogous to an ASIC. Therefore, the FPGA circuitry 800 may perform the operations corresponding to the some or all of the machine readable instructions of FIGS. 4 and/or 5 faster than the general purpose microprocessor can execute the same.

In the example of FIG. 8, the FPGA circuitry 800 is structured to be programmed (and/or reprogrammed one or more times) by an end user by a hardware description language (HDL) such as Verilog. The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain machine readable instructions to configure the FPGA circuitry 800, or portion(s) thereof. In some such examples, the configuration circuitry 804 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 806 may be implemented by external hardware circuitry. For example, the external hardware 806 may be implemented by the microprocessor 700 of FIG. 7. The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations that may correspond to at least some of the machine readable instructions of FIGS. 4 and/or 5 and/or other desired operations. The logic gate circuitry 808 shown in FIG. 8 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example Dedicated Operations Circuitry 814. In this example, the Dedicated Operations Circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the processor circuitry 612 of FIG. 6, many other approaches are contemplated. For example, as mentioned above, modern FPGA circuitry may include an on-board CPU, such as one or more of the example CPU 820 of FIG. 8. Therefore, the processor circuitry 612 of FIG. 6 may additionally be implemented by combining the example microprocessor 700 of FIG. 7 and the example FPGA circuitry 800 of FIG. 8. In some such hybrid examples, a first portion of the machine readable instructions represented by the flowchart of FIGS. 4 and/or 5 may be executed by one or more of the cores 702 of FIG. 7, a second portion of the machine readable instructions represented by the flowchart of FIGS. 4 and/or 5 may be executed by the FPGA circuitry 800 of FIG. 8, and/or a third portion of the machine readable instructions represented by the flowchart of FIGS. 4 and/or 5 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the processor circuitry 612 of FIG. 6, which may be in one or more packages. For example, the XPU may include a CPU in one package, a DSP in another package, a GPU in yet another package, and an FPGA in still yet another package.

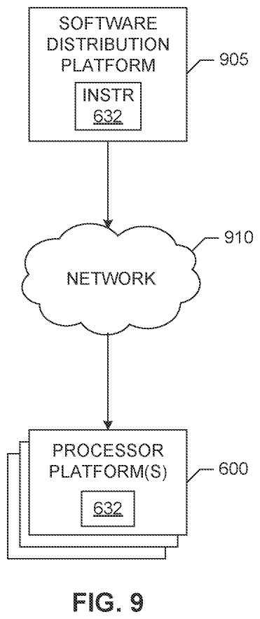

A block diagram illustrating an example software distribution platform 905 to distribute software such as the example machine readable instructions 632 of FIG. 6 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions 400, 412 of FIGS. 4 and/or 5, as described above. The one or more servers of the example software distribution platform 905 are in communication with an example network 910, which may correspond to any one or more of the Internet and/or any of the example networks 114 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions 400, 412 of FIGS. 4 and/or 5, may be downloaded to the example processor platform 600, which is to execute the machine readable instructions 632 to implement the example AI-based model training circuitry 112. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices.

From the foregoing, it will be appreciated that example systems, methods, apparatus, and articles of manufacture have been disclosed that train an artificial intelligence-based model. Disclosed systems, methods, apparatus, and articles of manufacture improve the efficiency of using a computing device by using a feed forward training protocol for AI-based models that avoids the heavy computational demand of conventional back-propagation techniques. In this manner, by using a sinusoidal signal based on misclassification to adjust weights, examples disclosed herein reduce the amount of time and resources to train an AI-based model. Disclosed systems, methods, apparatus, and articles of manufacture are accordingly directed to one or more improvement(s) in the operation of a machine such as a computer or other electronic and/or mechanical device.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to train an artificial intelligence (AI)-based model, the apparatus comprising:
memory;
computer readable instructions; and
processor circuitry to execute the computer readable instructions to:
generate a location value for a neuron in an AI-based model;
adjust a characteristic a sinusoidal signal based on a misclassification output by the AI-based model;
determine that a trajectory of the sinusoidal signal is within a threshold distance of the location value;
adjust the location value in response to the trajectory being within the threshold distance; and
adjust a weight that corresponds to the neuron based on the adjusted location value.

2. The apparatus of claim 1, wherein the location value corresponds to an x-coordinate and a y-coordinate.

3. The apparatus of claim 1, wherein the characteristic includes at least one of a shift, a frequency, a period, a number of sinusoids, an offset, a number of points, a height, a width, or an amplitude.

4. The apparatus of claim 1, wherein the processor circuitry is to:
input training data into the AI-based model to generate an output;
compare the output of the AI-based model to an output of the training data to generate an error; and
adjust the characteristic of the sinusoidal signal based on the error.

5. The apparatus of claim 1, wherein the processor circuitry is to adjust the location value based on the trajectory of the sinusoidal signal.

6. The apparatus of claim 1, wherein the weight corresponds to a distance between the neuron and a neuron of a subsequent layer of the AI-based model.

7. The apparatus of claim 1, wherein the processor circuitry is to deploy the AI-based model.

8. A non-transitory computer readable medium comprising instructions which, when executed, cause one or more processors to at least:
determine a location of a neuron in an artificial intelligence (AI)-based model;
adjust a sinusoidal signal based on an output of the AI-based model;
detect that a trajectory of the sinusoidal signal is within a threshold distance of the location of the neuron;
adjust the location of the neuron in response to the trajectory being within the threshold distance; and
tune a weight corresponding to the neuron based on the adjusted location of the neuron.

9. The computer readable medium of claim 8, wherein the location corresponds to a location on a coordinate plane.

10. The computer readable medium of claim 8, wherein the instructions are to adjust the sinusoidal signal by adjusting at least one of a shift, a frequency, a period, a number of sinusoids, an offset, a number of points, a height, a width, or an amplitude.

11. The computer readable medium of claim 8, wherein the instructions cause the one or more processors to:
determine an output of the AI-based model based on training data;
compare the output of the AI-based model to a labelled output of the training data to generate an error; and
adjust the sinusoidal signal based on the error.

12. The computer readable medium of claim 8, wherein the instructions cause the one or more processors to adjust the location based on the trajectory of the sinusoidal signal.

13. The computer readable medium of claim 8, wherein the weight corresponds to a distance between the location of the neuron and a location of a neuron of a subsequent layer of the AI-based model.

14. The computer readable medium of claim 8, wherein the instructions cause the one or more processors to store the AI-based model.

15. An apparatus to train an artificial intelligence (AI)-based model, the apparatus comprising:
interface circuitry to obtain training data; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
location determination circuitry to determine a location value for a neuron in an AI-based model;
sinusoid generation circuitry to change a characteristic a sinusoidal signal when the AI-based model misclassifies data;
the location determination circuitry to, determine that a trajectory of the sinusoidal signal is within a threshold distance of the location value;
change the location value in response to the trajectory being within the threshold distance; and
weight determination circuitry to change a weight that corresponds to the neuron based on the location value.

16. The apparatus of claim 15, wherein the location value corresponds to a location on a grid.

17. The apparatus of claim 15, wherein the characteristic includes at least one of a shift, a frequency, a period, a number of sinusoids, an offset, a number of points, a height, a width, or an amplitude.

18. The apparatus of claim 15, wherein the interface circuitry to input training data into the AI-based model to generate an output, the processor circuitry further to instantiate a comparator to compare the output of the AI-based model to an output of the training data to generate an error, the sinusoid generation circuitry to change the characteristic of the sinusoidal signal based on the error.

19. The apparatus of claim 15, wherein the location determination circuitry is to change the location value based on the trajectory of the sinusoidal signal.

20. The apparatus of claim 15, wherein the weight corresponds to a length of a connection between the neuron and a neuron of a subsequent layer of the AI-based model.
